(19) United States
(12) Patent Application Publication
(10) Pub. No.: US 2024/0310066 A1
(43) Pub. Date: Sep. 19, 2024

(54) AIR QUALITY MONITORING AND MANAGEMENT SYSTEM AND METHOD OF CONTROLLING THE SAME

(71) Applicant: Qatar Foundation for Education, Science and Community Development, Doha (QA)

(72) Inventors: Abdlmonem Hasan Beitelmal, Doha (QA); Mohammed Ali Ayoub, Doha (QA)

(21) Appl. No.: 18/574,405

(22) PCT Filed: Jun. 27, 2022
(86) PCT No.: PCT/QA2022/050013

§ 371 Date: Dec. 27, 2023

Related U.S. Application Data
(60) Provisional application No. 63/215,719, filed on Jun. 28, 2021.

(51) Int. Cl. F24F 11/63; F24F 11/00; F24F 11/52; F24F 110/52; F24F 110/64; F24F 110/65; F24F 110/66; F24F 110/70; F24F 110/72

(52) U.S. Cl. CPC F24F 11/63; F24F 11/0001; F24F 11/52; F24F 2011/0002; F24F 2110/52; F24F 2110/64; F24F 2110/65; F24F 2110/66; F24F 2110/70; F24F 2110/72

(57) ABSTRACT

A system of air quality monitoring and management is provided. The system includes a plurality of indoor air quality sensors, a communication unit configured to communicate with the indoor air quality sensors, and a controller. The controller is configured to receive measured data from the indoor air quality sensors and determine an indoor air quality value inside a building.

### CROSS REFERENCE TO RELATED APPLICATION

The present application claims priority to U.S. Provisional Patent Application No. 63/215,719, filed Jun. 28, 2021, the disclosure of which is incorporated into this specification by reference in its entirety.

### BACKGROUND

Maintaining desirable air quality indoors is both beneficial to our health and well-being, and can be a very challenging task. It can be particularly challenging for three reasons. First, both indoor and outdoor air quality changes frequently making it necessary to frequently monitor and adjust air quality improvement methods. Second, when indoor contamination occurs, the contaminated air is trapped. Third, determining when to introduce fresh air is dependent on many variables such as temperature, humidity, air quality, and presence of pollutants, among many others.

### SUMMARY

The present disclosure generally relates to an air quality monitoring and management system and method of controlling the same.

In light of the present disclosure, and without limiting the scope of the disclosure in any way, in an aspect of the present disclosure, which may be combined with any other aspect listed herein unless specified otherwise, a system of air quality monitoring and management is provided. The system includes a plurality of indoor air quality sensors, a communication unit configured to communicate with the indoor air quality sensors, and a controller. The controller is configured to receive measured data from the indoor air quality sensors and determine an indoor air quality value inside a building.

In an aspect of the present disclosure, which may be combined with any other aspect listed herein unless specified otherwise, the system further comprising a plurality of outdoor air quality sensors.

In an aspect of the present disclosure, which may be combined with any other aspect listed herein unless specified otherwise, the controller is configured to receive measured data from the outdoor air quality sensors and determine an outdoor air quality value outside the building.

In an aspect of the present disclosure, which may be combined with any other aspect listed herein unless specified otherwise, the indoor air quality is undesirable when the indoor air quality value is equal to or above a first predetermined value.

In an aspect of the present disclosure, which may be combined with any other aspect listed herein unless specified otherwise, the indoor air quality is desirable when the indoor air quality value is below a first predetermined value.

In an aspect of the present disclosure, which may be combined with any other aspect listed herein unless specified otherwise, the outdoor air quality is undesirable when the outdoor air quality value is equal to or above a second predetermined value.

In an aspect of the present disclosure, which may be combined with any other aspect listed herein unless specified otherwise, the outdoor air quality is desirable when the outdoor air quality value is below a second predetermined value.

In an aspect of the present disclosure, which may be combined with any other aspect listed herein unless specified otherwise, the indoor air quality sensors include at least one of a PM_{2.5} sensor, a PM₁₀ sensor, a CO₂ sensor, a NO₂ sensor, a temperature sensor, a humidity sensor or a Volatile Organic Compound (VOC) sensor.

In an aspect of the present disclosure, which may be combined with any other aspect listed herein unless specified otherwise, the indoor air quality sensors include at least one of a PM_{2.5} sensor, a PM₁₀ sensor, a CO₂ sensor, a NO₂ sensor or a VOC sensor.

In an aspect of the present disclosure, which may be combined with any other aspect listed herein unless specified otherwise, the air quality monitoring and management system sends alarms, warning messages, or information to a mobile device when the indoor air quality value is equal to or above a first predetermined value.

In an aspect of the present disclosure, which may be combined with any other aspect listed herein unless specified otherwise, the controller controls a fresh intake air damper to open when the indoor air quality value minus the outdoor air quality value is larger than a predetermined value.

In an aspect of the present disclosure, which may be combined with any other aspect listed herein unless specified otherwise, the controller controls a fresh intake air damper to close when the outdoor air quality value is larger than a reference value.

In an aspect of the present disclosure, which may be combined with any other aspect listed herein unless specified otherwise, the air quality monitoring and management system sends notification to open a window of the building when the indoor air quality value is equal to or above a first predetermined value.

In an aspect of the present disclosure, which may be combined with any other aspect listed herein unless specified otherwise, the air quality monitoring and management system sends notification to close a window of the building when the outdoor air quality value is equal to or above a second predetermined value.

In an aspect of the present disclosure, which may be combined with any other aspect listed herein unless specified otherwise, the controller is configured to determine whether an air contamination is from an indoor air source or an outdoor air source.

The reader will appreciate the foregoing details, as well as others, upon considering the following detailed description of certain non-limiting embodiments including a smart air quality monitor and a system of the same according to the present disclosure.

### BRIEF DESCRIPTION OF THE DRAWINGS

Features and advantages of the systems and methods described herein may be better understood by reference to the accompanying drawing in which:

FIG. 1 is a schematic illustration of an air quality monitoring and management system according to an embodiment of the present disclosure.

FIG. 2 is an illustration of a control method of an air quality monitoring and management system according to an embodiment of the present disclosure.

FIG. 3 is an illustration of an air quality monitoring and management system according to an embodiment of the present disclosure.

The reader will appreciate the foregoing details, as well as others, upon considering the following detailed description of certain non-limiting embodiments of the present disclosure.

### DETAILED DESCRIPTION

The present disclosure generally relates to an air quality monitoring and management system and a method of controlling the same.

The embodiments are described more fully hereinafter with reference to the accompanying drawings, in which some, but not all embodiments of the present technology are shown. Indeed, the present technology may be embodied in many different forms and should not be construed as limited to the embodiments set forth herein.

Likewise, many modifications and other embodiments of an air quality monitoring and management system and a method of controlling the same described herein will come to mind to one of skill in the art to which the invention pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Throughout the specification and claims, terms may have nuanced meanings suggested or implied in context beyond an explicitly stated meaning. Likewise, the phrase “in an embodiment” as used herein does not necessarily refer to the same embodiment or implementation and the phrase “in another embodiment” as used herein does not necessarily refer to a different embodiment or implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The terminology used herein is for the purpose of describing particular example embodiments only and is not intended to be limiting. The terms “comprise”, “comprises”, “comprised” or “comprising”, “including” or “having” and the like in the present specification and claims are used in an inclusive sense, that is to specify the presence of the stated features but not preclude the presence of additional or further features.

Air quality has been a growing issue for decades. Air quality is typically in the context of outdoor pollutants such as smog, car exhaust, or smoke. The negative effects of poor outdoor air quality on an individual's health have been well studied. In recent years, the focus is moving to the negative effects of poor indoor air quality on a person's health.

During the COVID-19 pandemic, many people may be spending more time indoors, thus maintaining desirable air quality indoors is both beneficial to our health and well-being, and can be a very challenging task. In the present disclosure, a smart indoor air quality system and/or platform is provided to manage the indoor air quality inside a building or a house.

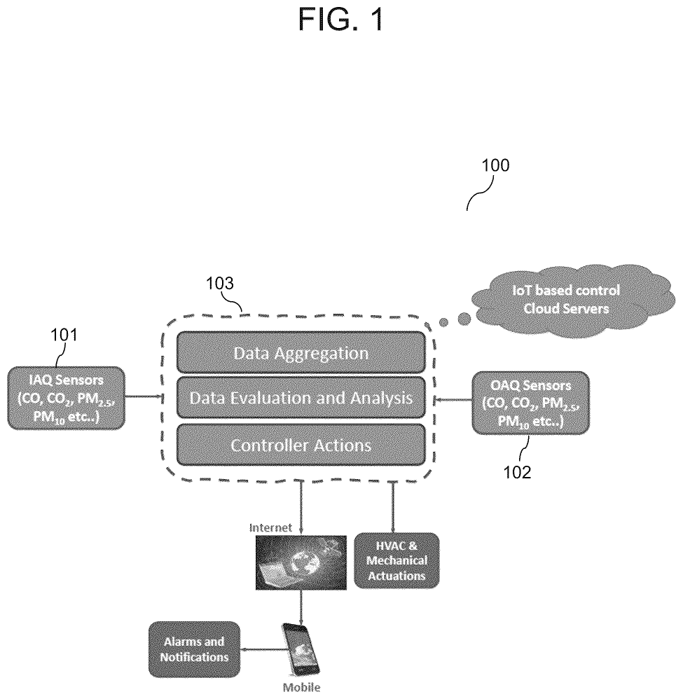

According to an embodiment of the present disclosure, a system of air quality monitoring and management is developed. As illustrated in FIG. 1, the system 100 includes a plurality of indoor air quality (IAQ) sensors 101 provided inside a building or a house and a plurality of outdoor air quality (OAQ) sensors 102 provided outside the building or the house. The indoor air quality sensors may include at least one of a particulate matter (PM) sensor, a CO sensor, a CO₂ sensor, a NO₂ sensor, a temperature (T) sensor, a humidity or relative humidity (RH) sensor or a Volatile Organic Compound (VOC) sensor. The PM sensor is used to detect and monitor particles in a given environment such as the building or the house. The PM sensor can include any suitable type of particulate matter sensor such as PM_{2.5} sensor and/or PM₁₀ sensor. The PM_{2.5} sensor is able to count and measure the particles that are 2.5 microns or smaller in diameter. The PM₁₀ sensor is able to count and measure the particles with a diameter between 2.5 microns and 10 microns. The CO sensor, for example, is a type of sensor configured to detect and measure even slightly increased amounts of carbon monoxide, which are enough to affect people's health over time. The CO₂ sensor, for example, is a type of sensor configured to monitor and detect for the presence of carbon dioxide in the given environment. The NO₂ sensor, for example, is a type of sensor configured to measure low ambient levels of NO₂ in the given environment that may be associated with the irritation of the eyes, nose, throat, and lungs. The temperature sensor, for example, is type of sensor used to measure an ambient or environmental temperature inside or outside the building or the house. The humidity or relative humidity sensor, for example, is a type of sensor configured to measure the humidity and moisture level in the given environment. Volatile organic compounds (VOCs) are harmful to the atmospheric environment and human life, so it is necessary to quickly identify the presence of VOCs in the air. The VOC sensor is used when it is desirable to detect and identify the presence of VOCs in the given environment. According to an embodiment, the indoor air quality sensors including at least one of a particulate matter (PM) sensor, a CO sensor, a CO₂ sensor, a NO₂ sensor, a temperature sensor, a humidity or relative humidity sensor or a Volatile Organic Compound (VOC) sensor may be integrated into a single device. According to another embodiment, the indoor air quality sensors may be physically separated from each other and strategically distributed into one or more spaces in the building or the house. The indoor air quality sensors may be communicatively connected or coupled with the air quality monitoring and management system via hard wires or wireless communication.

The indoor air quality sensors are used to monitor the environment and air quality inside the building or the house. The indoor air quality sensors are strategically distributed in the building or the house. The system 100 further includes a control device 103 that includes a communication unit and a controller. The communication unit may include a receiver, a transmitter, an antenna or the like to communicate with the indoor air quality sensors 101 and/or the outdoor air quality sensors 102. The controller includes at least one of a central processing unit (CPU), a processor or the like. The controller is coupled with the communication unit and is configured to receive the measured data from the indoor air quality sensors (101) and/or the measured data from the outdoor air quality sensors (102). The control device 103 performs desirable processes such as data aggregation, data evaluation and analysis after it receives measured data from the indoor air quality sensors 101 and/or the outdoor air quality sensor 102. The control device can also communicate with a mobile phone via internet or base station by using the communication unit. For example, the control device is capable of sending notifications, alarms, warning messages, or information to the mobile phone. According to an embodiment, the control device can also communicate with heating, ventilation, and air conditioning (HVAC) and mechanical devices and send control signals to activate the HVAC and/or mechanical devices in the building or the house. The air quality monitoring and management system can perform Internet of Things (IoT) based control as well through cloud servers according to another embodiment.

According to another embodiment of the present disclosure, a smart indoor air quality monitoring and management platform is provided. The platform includes both indoors and outdoors air quality sensor and is able to control an automated fresh intake air damper (AFIAD) or to push a notification with recommendations to a user or occupant of the building in which the platform is installed. The automated fresh intake air damper (AFIAD), for example, is a power-open, power-close motorized air damper that is installed in a fresh air ventilation duct connected to an outdoor air intake hood and a duct fan or the HVAC return plenum, to control the flow of fresh air into the building or the house. The present technology provides, for example, optimization of indoor air quality by using outdoor air when possible and identification of the location of a source of air contamination according to an embodiment. The smart indoor air quality may do the following according to an embodiment of the present disclosure:
Receive measurement or predicted indoor air quality data (indoor and outdoor).
Assess and identify based on predetermined limits whether each of the IAQ value is within an acceptable level.
Assess and identify based on predetermined limits whether each of the OAQ value is within an acceptable level.
There are four scenarios:
   1. OAQ=undesirable, IAQ=desirable
   2. OAQ=desirable, IAQ=undesirable
   3. OAQ=desirable, IAQ=desirable
   4. OAQ=undesirable, IAQ=undesirable

The controller is configured to determine an indoor air quality value inside the building or the house based on the measured data from the indoor air quality sensors. For example, the indoor air quality is considered as desirable when the calculated indoor air quality value is below a first predetermined value; and the indoor air quality is considered as undesirable when the calculated indoor air quality value is equal to or above the first determined value. The controller is also configured to determine an outdoor air quality value outside the building or the house based on the measured data from the outdoor air quality sensors. For example, the outdoor air quality is considered as desirable when the calculated outdoor air quality value is below a second predetermined value; and the outdoor air quality is considered as undesirable when the calculated outdoor air quality value is equal to or above the second determined value.

According to another embodiment of the present disclosure, the system may optimize indoor air quality by opening an AFIAD or instructing a user to open windows when outdoor air quality (OAQ) is better than indoor air quality (IAQ). Conversely, when OAQ is worse than IAQ, the AFIAD would close outdoor air intake and a notification would instead instruct a user to close windows. In this way, IAQ is improved by taking advantage of beneficial outdoor air and rejecting outdoor air that would worsen IAQ. The following are the mitigation plans according to an embodiment of the present disclosure:
1. Close AFIAD 100%.
2. Open AFIAD 100%
3. Open AFIAD as per the energy efficiency and thermal comfort requirements.
4. Do further assessment between IAQ and OAQ to determine best approach

If the AFIAD is not available, notifications may be sent through mobile apps to the end-user for further actions (open/close windows) in addition to alarms or warnings according to an embodiment.

According to an embodiment of the present disclosure, the following metrics may be used to make a decision on opening or closing the automated fresh air intake damper (AFIAD) or provide warnings/alerts or recommendations to close/open windows with a goal of optimizing the indoor air quality; and also determining if the pollution source is indoor or outdoor.

[X₁, X₂, Y₁, Y₂, R, (ROC)ᵢₙ, (ROC)ₒᵤₜ]
Indoor to Outdoor ratio

$$R = ( \frac{{S}_{in}}{{S}_{out}} )$$

$${X}_{1} = ( \frac{{S}_{in} - {S}_{{in}_{MTH}}}{{S}_{{in}_{MTH}}} ) \times 100$$

$${X}_{2} = ( \frac{{S}_{in} - {S}_{{in}_{STH}}}{{S}_{{in}_{STH}}} ) \times 100$$

$${Y}_{1} = ( \frac{{S}_{out} - {S}_{{out}_{MTH}}}{{S}_{{out}_{MTH}}} ) \times 100$$

$${Y}_{2} = ( \frac{{S}_{out} - {S}_{{out}_{STH}}}{{S}_{{out}_{STH}}} ) \times 100$$

$${( ROC )}_{in} = ( \frac{{S}_{in} ( t + {Δ}_{t} ) - {S}_{in} ( t )}{{Δ}_{t}} )$$

$${( ROC )}_{out} = ( \frac{{S}_{out} ( t + {Δ}_{t} ) - {S}_{out} ( t )}{{Δ}_{t}} )$$

$$Positive ( ROC ) ≡ Increasing$$

$$Negative ( ROC ) ≡ Decreasing$$

Indoor Sensors
   (PM_{2.5}, PM₁₀, CO, CO₂, NO₂, VOC, T, RH, etc. . . . )
Outdoor Sensors
   (PM_{2.5}, PM₁₀, CO, CO₂, NO₂, VOC, T, RH, etc. . . . )
   S≡Parameter value measured
   MTH≡Moderate threshold value or (range)
   STH≡Severe threshold value or (range)
   Δt≡Time internal
   RoC≡Rate of change
Subscripts
   in≡Indoor
   out≡Outdoor
   t≡time
   R≡indoor to outdoor ratio

The symbol R is the ratio between the outdoor sensor value and the indoor sensor value. For example, if R is less than 1, then the value of the outdoor sensor is greater than the indoor value and vise versa. The controller will use either or both threshold values and the ratio to make the decision. For example, if both OAQ and IAQ are desirable, then the ratio R can help determine if we open or close the AFIAD. The same is true if both OAQ and IAQ are undesirable. The metrics, for example, X₁, X₂, Y₁ and Y₂ provide percentage values of how close the current parameter value from the severe or moderate threshold values. The symbol ROC is the rate of change of the sensor value. This provides information of how fast the sensor value is increasing or decreasing say for example due to opening or closing the AFIAD. This information, will help determine how long it takes to mitigate indoor contamination. For example, positive and negative ROC values are indicative of worsening or improving the indoor air quality respectively.

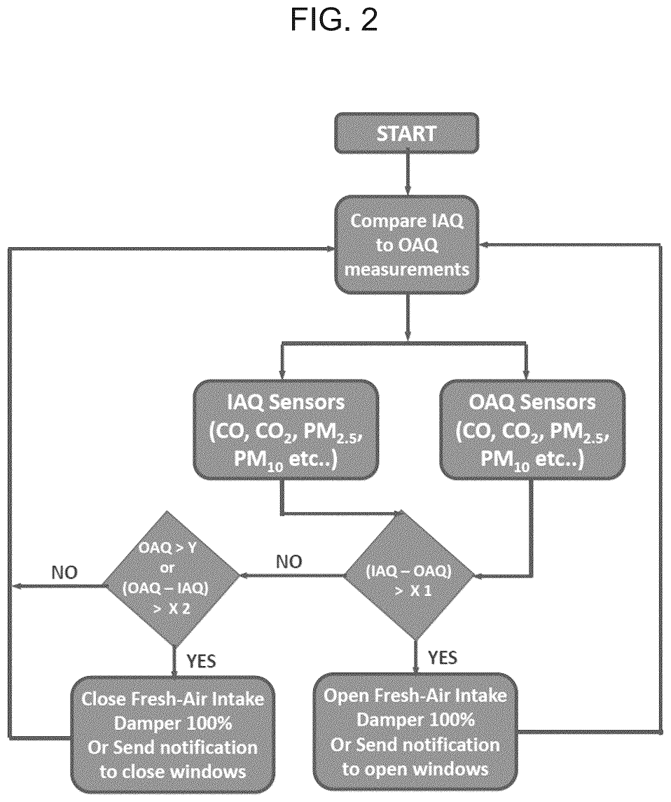

FIG. 2 illustrates a control method of an air quality monitoring and management system according to an embodiment of the present disclosure. The air quality monitoring and management system has similar configuration or structure as other embodiments as described in the present disclosure. The system firstly compares the indoor air quality measurement results measured by the IAQ sensors with the outdoor air quality measurement results measured by OAQ sensors. The indoor air quality measurement results include an indoor air quality value that is calculated based on the measured data of IAQ sensors such as values of CO, CO₂, PM_{2.5}, PM₁₀, etc. The outdoor air quality measurement results include an outdoor air quality value that is calculated based on the measured data of OAQ sensor such as values of CO, CO₂, PM_{2.5}, PM₁₀, etc. To manage and maintain desirable indoor air quality, the system performs following controls according to an embodiment. For example, when the indoor air quality (IAQ) value minus the outdoor air quality (OAQ) value is larger than a predetermined value (X₁), then the system (e.g., the controller) controls a fresh air intake damper to open or send notification or alarms to a user to open at least a window in the building or the house. When the indoor air quality (IAQ) value minus the outdoor air quality (OAQ) value is less than or equal to the predetermined value (X), then the system will further evaluate whether or not the outdoor air quality (OAQ) value is larger than a reference value (Y). If the outdoor air quality (OAQ) value is larger than a reference value (Y), it means the outdoor air quality is worse than the indoor air quality, and the system will control to close the fresh air intake damper and/or a notification would instead instruct a user to close windows in the building or the house. Similarly, if the outdoor air quality (OAQ) value minus the indoor air quality (IAQ) value is larger than a predetermined value (X₂), then the system will control to close the fresh air intake damper and/or a notification would instead instruct a user to close windows in the building or the house. It should be understood that the air quality value can be calculated and represented by a single value (e.g., any value of the parameters measured by the IAQ sensors and/or OAQ sensors), or a bulk value based on the values of the measured parameters of air quality. For example, in an embodiment, the system may control the fresh intake air damper to open or close based on the priority order in terms of standard health restrictions and options with the least impact of the occupants when one or more parameters are higher and another one or more are lower within the IAQ and/or OAQ values.

According to another embodiment of the present disclosure, the system may also be able to locate a source of air contamination from an inside air source, an outside air source or both, and may be further narrowed to a specific room or zone depending on the sensor array. The system would then be able to conduct some actions depending on the location of the contamination. For example, if there was indoor air contamination, the system may open the AFIAD and/or instruct a user or uses to open at least a window of the building in order to introduce non-contaminated fresh outdoor air.

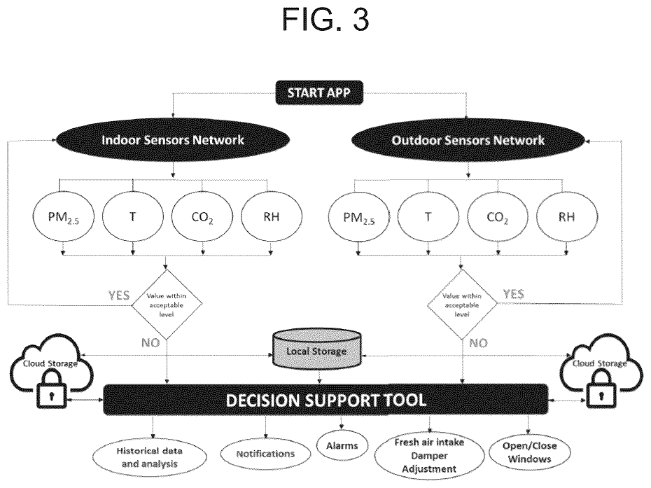

According to another embodiment of the present disclosure, an air quality monitoring and management platform is provided. As illustrated in FIG. 3, the platform includes a plurality of indoor and outdoor air quality sensors, a controller, a communication unit and a local storage. The controller may be a software such as an application according to an embodiment. The communication unit may include a receiver, a transmitter, an antenna or the like to have Ethernet, protocol, network and/or WiFi connectivity. For example, the air quality monitoring and management platform is able to be connected with cloud server to receive environmental information such as air quality information in certain areas. The historical data and analysis information on the air quality in certain areas can also be downloaded and/or updated to the local storage of the platform. The controller may be a hardware or a combination of a software and a hardware. For example, the controller may include at least one of a central processing unit (CPU), a processor or the like. The controller is coupled with the communication unit and is configured to receive the measured data from the indoor air quality sensors and/or the measured data from the outdoor air quality sensors, and perform the required analysis to determine if the indoor air quality variables values are within the acceptable ranges. The indoor air quality sensors may include a particulate matter (PM) sensor such as PM_{2.5} sensor and/or PM₁₀ sensor, a CO sensor, a CO₂ sensor, a NO₂ sensor, a temperature (T) sensor, a humidity or relative humidity (RH) sensor or a Volatile Organic Compound (VOC) sensor and communicatively coupled with each other to constitute an indoor sensors network. The outdoor air quality sensors may include a particulate matter (PM) sensor such as PM_{2.5} sensor and/or PM₁₀ sensor, a CO sensor, a CO₂ sensor, a NO₂ sensor, a temperature (T) sensor, a humidity or relative humidity (RH) sensor or a Volatile Organic Compound (VOC) sensor and communicatively coupled with each other to constitute an outdoor sensors network. The outdoor air quality sensors may be optional and replaced by accessing to appropriate data from an external weather site, air quality monitoring station or cloud storage according to an embodiment.

As illustrated in FIG. 3, an application may send request to indoor sensors network and/or outdoor sensors network for the measured data about the air quality inside or outside the building or the house. If the indoor air quality sensors' values are below acceptable levels, then the application will try to determine whether the source(s) of contaminations are indoor or outdoor. For example, if the indoor air quality sensors' values are within the acceptable levels, but outdoor air quality sensors' values are below acceptable levels, then the application may determine that the source of contaminations are outdoor. The application may further evaluate and determine whether there is a need to shut down the fresh air intake temporarily. Other actions such as alarms, warning messages and information can be provided through mobile devices so that the occupants can be informed and recommended mitigations can be taken. On the other hand, if the indoor air quality sensors' values are below acceptable levels, but the outdoor air quality sensors' values are within acceptable levels, then the application may determine that the source of contaminations are indoor. The application may further evaluate and determine whether there is a need to open fresh air intake damper or open the windows of the building or the house accordingly.

According to another embodiment of the present disclosure, an air quality monitoring and management system is provided. The system includes a carrier device where selected indoor air quality sensors are connected and strategically distributed inside the home or building. The platform is also hard-wired or wirelessly connected to outdoor air quality sensors. The information required can also be obtained from a reliable local air quality depository. The platform is equipped with a control system to measure the indoor air quality sensors, compare to the outdoor air quality sensors readings, and conduct the comparison process described in the control logic. The controller will evaluate the indoor and outdoor sensor readings and determine if the readings are within the acceptable range or not. If the indoor air quality is outside the acceptable range then the controller will proceed with a number of steps to further evaluate the situation. The controller analysis will arrive at a determination of the source of the contamination (indoor, outdoor, or both). The controller will provide information to the end-users/occupants about the findings and recommend proper mitigation plans. The controller may adjust the fresh air intake's percentage of opening according to the situation requirement if an automated damper is connected to the controller.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An air quality monitoring and management system, comprising:
a plurality of indoor air quality sensors,
a communication unit configured to communicate with the indoor air quality sensors, and a controller,
wherein the controller is configured to receive measured data from the indoor air quality sensors and determine an indoor air quality value inside a building.

2. The air quality monitoring and management system according to claim 1, further comprising a plurality of outdoor air quality sensors.

3. The air quality monitoring and management system according to claim 2, wherein the controller is configured to receive measured data from the outdoor air quality sensors and determine an outdoor air quality value outside the building.

4. The air quality monitoring and management system according to claim 1, wherein the indoor air quality is undesirable when the indoor air quality value is equal to or above a first predetermined value.

5. The air quality monitoring and management system according to claim 1, wherein the indoor air quality is desirable when the indoor air quality value is below a first predetermined value.

6. The air quality monitoring and management system according to claim 3, wherein the outdoor air quality is undesirable when the outdoor air quality value is equal to or above a second predetermined value.

7. The air quality monitoring and management system according to claim 3, wherein the outdoor air quality is desirable when the outdoor air quality value is below a second predetermined value.

8. The air quality monitoring and management system according to claim 1, wherein the indoor air quality sensors include at least one of a PM_{2.5} sensor, a PM₁₀ sensor, a CO₂ sensor, a NO₂ sensor, a temperature sensor, a humidity sensor or a Volatile Organic Compound (VOC) sensor.

9. The air quality monitoring and management system according to claim 2, wherein the indoor air quality sensors include at least one of a PM_{2.5} sensor, a PM₁₀ sensor, a CO₂ sensor, a NO₂ sensor or a VOC sensor.

10. The air quality monitoring and management system according to claim 1, wherein the air quality monitoring and management system sends alarms, warning messages, or information to a mobile device when the indoor air quality value is equal to or above a first predetermined value.

11. The air quality monitoring and management system according to claim 3, wherein the controller controls a fresh intake air damper to open when the indoor air quality value minus the outdoor air quality value is larger than a predetermined value.

12. The air quality monitoring and management system according to claim 3, wherein the controller controls a fresh intake air damper to close when the outdoor air quality value is larger than a reference value.

13. The air quality monitoring and management system according to claim 1, wherein the air quality monitoring and management system sends notification to open a window of the building when the indoor air quality value is equal to or above a first predetermined value.

14. The air quality monitoring and management system according to claim 3, wherein the air quality monitoring and management system sends notification to close a window of the building when the outdoor air quality value is equal to or above a second predetermined value.

15. The air quality monitoring and management system according to claim 1, wherein the controller is configured to determine whether an air contamination is from an indoor air source or an outdoor air source.
